(19) United States
(12) Patent Application Publication
(10) Pub. No.: US 2001/0038173 A1
(43) Pub. Date: Nov. 8, 2001

(54) Shock absorbing system for four-wheel vehicle

(76) Inventor: Seiji Sawai, Shizuoka (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/842,344

(22) Filed: Apr. 25, 2001

(30) Foreign Application Priority Data
Apr. 27, 2000 (JP) 2000-127183

(51) Int. Cl. F16F 5/00

(52) U.S. Cl. 267/140.11; 267/217

(57) ABSTRACT

A suspension system comprises two sets of interconnected cylinders. Each of the sets comprises a pressure regulating component having a high pressure chamber. In some arrangements, the high pressure chamber is commonly formed between the two sets. In other arrangements, the high pressure chambers are connected by an auxiliary passage.

### RELATED APPLICATIONS

This application is related to and claims the priority of Japanese Patent Application No. 2000-127,183, which was filed on Apr. 27, 2000, the entire contents of which is hereby expressly incorporated by reference.

### BACKGROUND OF THE INVENTION

1. Field of the Invention

The present invention generally relates to interrelated suspension systems for vehicles. More particularly, the present invention relates to such interrelated suspension systems having interrelated pressure regulating members.

2. Description of the Related Art

Suspension systems are used in automobiles and various other vehicles for controlling the movement of a body of the vehicle relative to a surface over which the vehicle is being operated. For instance, in many applications, the vehicle comprises a frame and a number of wheels that support the frame. A suspension system assembly is interposed between the wheels and the frame. Generally, the frame and the wheels are separated by a spring and damper configuration. The spring and damper configuration controls the amount of relative movement between the wheels and the frame as the wheels encounter varying degrees of bumps and other surface irregularities while operating over uneven terrain.

### SUMMARY OF THE INVENTION

An example of such a suspension system has been described in laid-open Japanese Patent Application No. HE18-132846, which was published on May 28, 1996 and which was assigned to Yamaha Motor Co. Ltd. This suspension system, which is generally indicated by the reference numeral 10, will be described with reference to FIG. 1, which has been labeled as prior art. As illustrated therein, four identical oil cylinders 12, 14, 16, 18 are provided. The oil cylinder 12 is provided for a front-left tire of the vehicle while the cylinder 18 is provided for the rear-right wheel of the vehicle. Similarly, the other two cylinders 14, 16 correspond to the left-rear tire and the front-right tire, respectively. The front-left cylinder 12 and the rear-right cylinder 18 are connected through a first pressure regulator 20 while the left-rear cylinder 14 and the right-front cylinder 16 are connected through a second pressure regulator 22.

In the illustrated arrangement, each of the cylinders 12, 14, 16, 18 is identically constructed. Accordingly, the construction of the cylinders will be described with reference only to the front-left cylinder 12 but should be understood to apply to the other three cylinders 14, 16, 18. In the illustrated arrangement, the cylinder 12 is comprised of a cylinder body 24 that defines an inner chamber that is generally divided into an upper portion 26 and a lower portion 28 by a piston 30. The piston 30 generally forms a moveable wall. Of course, as used herein, moveable wall also can include diaphragm members, slideable members, expansible members, contractible members and the like. The illustrated piston 30 contains at least one passage 32 that contains a corresponding throttling member 34. Thus, the lower chamber 28 and the upper chamber 26 are fluidly connected through the aperture 32 and the flow therethrough is regulated by the throttle 34. The piston 30 is connected to a piston rod 36 and, in the illustrated arrangement, the piston rod 36 is connected to the wheel of the vehicle while the cylinder body 24 is connected to the vehicle body itself.

In the illustrated arrangement, the first pressure regulator 20 and the second pressure regulator 22 are similarly constructed. Accordingly, the construction of the first pressure regulator 20 also applies to the construction of the second pressure regulator 22. The pressure regulator 20 generally comprises a cylinder body 40. The cylinder body 40 defines therein a number of chambers. In particular, the cylinder body defines a lower gas chamber 42 and a pair of upper oil chambers 44, 46. More particularly, the cylinder body 40 comprises a large diameter lower portion 48 and a smaller diameter upper portion 50. A piston 52 is arranged for reciprocation within the larger diameter portion 48 and extends into the smaller diameter portion 50. In this arrangement, the oil chambers 44, 46, which are defined generally within the smaller diameter portion 50, also are interconnected through a throttle passage 53. Thus, if fluid flows from one oil chamber 44 to another oil chamber 46 through the throttle passage 53, the damping effect of the suspension system 10 is increased.

In the illustrated arrangement, the first oil chamber 44 of the first pressure regulator 20 is fluidly connected to the upper chamber 26 of the right-rear cylinder 18 while the second oil chamber 46 of the first pressure regulator 20 is connected to the upper chamber 26 of the front-left cylinder 12. Likewise, the first oil chamber 44 of the second pressure regulator 22 is fluidly connected to the upper chamber 26 of the front-right cylinder 14 while the second oil chamber 46 of the second pressure regulator 22 is fluidly connected to the upper chamber 26 of the left-rear cylinder 16. As discussed above, the first oil chamber 44 and the second oil chamber 46 of both pressure regulators 20, 22 are connected through the throttle passage 53.

Preferably, the pistons 52 are formed such that the effective cross-sectional area of the first oil chamber 44 is equal to that of the second oil chamber 46. In this manner, provided that the displacement from each of the oil cylinders 12, 18 and 14, 16 into the respective oil chambers 44, 46 is nearly the same, no flow will occur through the passage 48. Furthermore, in the illustrated arrangement, the high pressure gas chamber 42 urges the pistons 52 upward and towards the two oil chambers 44, 46. By urging the piston 52 towards the oil chambers 44, 46, cavitation can be reduced within the suspension system 10. As is known, cavitation often can be caused by excessively negative pressures within the hydraulic system 10.

In operation, when the wheel associated with the cylinder 12 encounters a bump, such that the piston rod 36 is urged upward and the piston 30 moves towards the upper chamber 26, a portion of the oil within the upper chamber 26 flows to the lower chamber 28 through the throttled passage 32. The throttle valve 34 positioned within the passage 32 acts to damp some of the movement of the cylinder body 24 relative to the piston rod 36. Another portion of the fluid from the chamber 26 is displaced through a fluid line 54 which leads into the second oil chamber 46 of the first pressure regulator 20. Because the movement is only with respect to one wheel, the displaced oil passes through the conduit 54 into the second chamber 46 and through the throttle passage 53 into the first chamber 44 rather than displacing the piston 52. Thus, the movement of the cylinder body 24 relative to the piston rod 36 is further damped by the flow through the throttle passage 53.

Furthermore, during use, when the interrelated cylinders 12, 18 or 14, 16 are moved in opposing directions, the damping force is further increase due to the flow through both the throttle passage 32 as well as the throttle passage 53 within the pressure regulator. However, when both of the piston rods 36 move relative to the cylinder bodies 24 in the same direction by about the same amount, the damping force is relatively decreased because there is no flow through the passage 53. Instead of flowing through the passage 53, the piston 52 is displaced. Thus, the pressure within the high pressure chamber 42 increases if the flow is into the pressure regulator and decreases if the flow is out of the pressure regulator. In some instances, displacement of the piston body 52 becomes difficult due to the high pressure within the chambers 42 generated within the chambers 42 by prior piston displacement.

In the situation where one interrelated set of dampers 12, 18 moves in one direction while the second interrelated set of dampers 14, 16 moves in the other direction, the movement of the pistons 52 within the respective pressure regulators 20, 22 would be in opposite directions. This movement in opposite directions results in an unnatural response characteristic for the suspension system 10. Namely, the movement of the piston 52 downward within the high pressure chamber 42 further increases the pressure within the high pressure chamber 42 and increases the spring rate associated with those cylinders 14, 16. Of course, when the piston 52 moves upward relative to the high pressure chamber 42, the pressure within the high pressure 42 drops thereby lowering the spring rate associated with that portion of the suspension system. The increased spring rate and the decreased spring rate reduces the desired control of the suspension system.

One manner of correcting such a response characteristic within the suspension system 10 is to increase effective cross-sectional area of the first and second oil chambers 44, 46. By increasing the cross-sectional areas of these chambers, less movement of the piston 52 is caused by displacement into or away from the pressure regulator 20, 22. Similarly, increasing the effective cross-sectional area of the high pressure chamber 42 also could decrease the displacement of the piston 52. By reducing the displacement of the piston 52, the variation in the effective spring rate, which is associated with the high pressure chambers 42, can be reduced.

A drawback to this approach, however, is that the size of the pressure regulators 20, 22 is thereby increased which decreases the mountability or the portability of the pressure regulators within the vehicle body. In other words, it becomes difficult to position the pressure regulators 20, 22 in desired locations within the vehicle body. In addition, the weight and size associated with the pressure regulators increases and the pressure regulators thereby displace other components from their desired position within the vehicle body.

Accordingly, an arrangement is desired in which two sets of interrelated dampers can be related together to decrease the large relative pressure swings between the high pressure gas chambers.

One aspect of the present invention involves a suspension system comprising a first cylinder and a second cylinder. The first cylinder and the second cylinder are fluidly connected to a first pressure regulator. The system further comprises a third cylinder and a fourth cylinder with the third cylinder and the fourth cylinder being fluidly connected to a second pressure regulator. The first pressure regulator contains a first high pressure chamber and the second pressure regulator contains a second high pressure chamber. The first high pressure chamber and the second high pressure chamber are in fluid communication.

Another aspect of the present invention involves a suspension system comprising a first cylinder, a second cylinder, a third cylinder and a fourth cylinder. The first cylinder and the second cylinder are fluidly connected to a first portion of a pressure regulating assembly. The third cylinder and the fourth cylinder are fluidly connected to a second portion of a pressure regulating assembly. The first portion of the pressure regulating assembly comprises a first fluid chamber while the second portion of the pressure regulating assembly comprises a second fluid chamber. The pressure regulating assembly further comprises a high pressure chamber disposed between the first fluid chamber and the second fluid chamber. A first moveable wall is positioned between the first fluid chamber and the high pressure chamber and a second moveable wall is positioned between the second fluid chamber and the high pressure chamber.

### BRIEF DESCRIPTION OF THE DRAWINGS

These and other features, aspects and advantages of the present invention will be described with reference to accompanying drawings. The drawings comprise seven figures.

FIG. 1 is a prior arrangement of a suspension system comprising two separately interrelated sets of dampers.

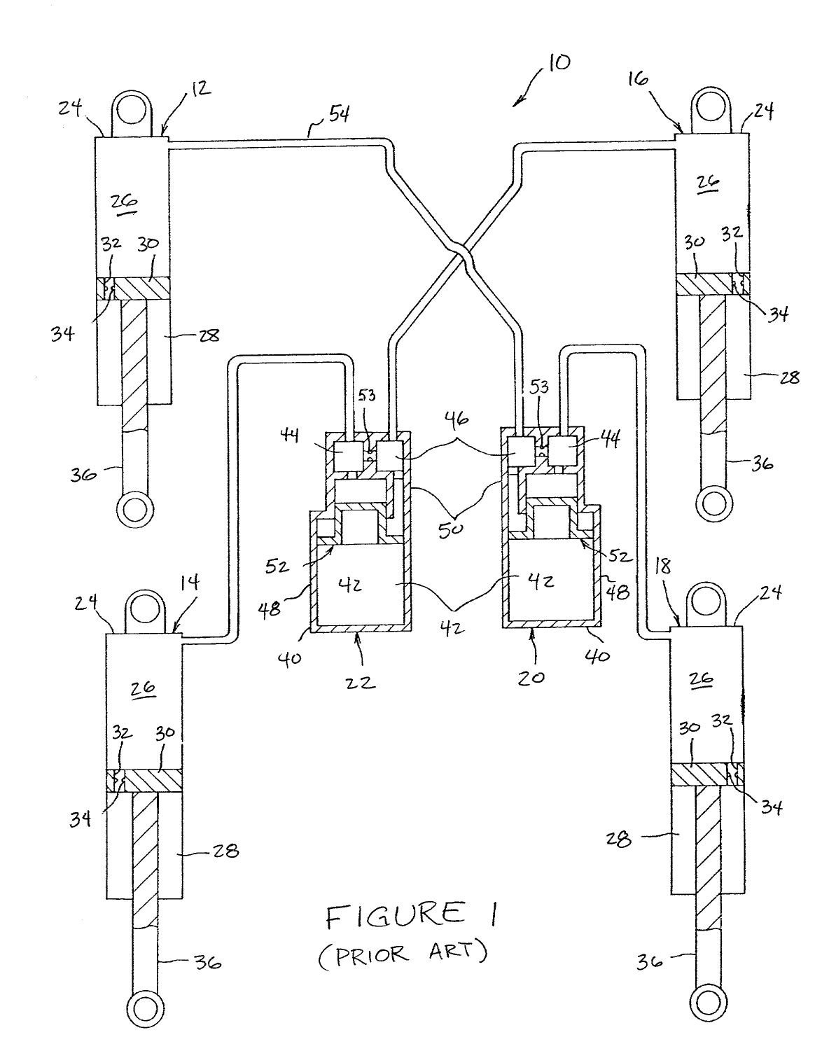

FIG. 2 is a presently preferred arrangement of an interrelated set of dampers comprising two interrelated sets, which sets are in themselves interrelated.

FIG. 3 is an enlarged cross-sectional view of a single damper and a configuration of a set of interrelated pressure regulators.

FIG. 4 is another arrangement featuring interrelated pressure regulators.

FIG. 5 is an enlarged cross-sectional view of the pressure regulators of the arrangement of FIG. 4.

FIG. 6 is another arrangement of an interrelated pressure regulator assembly.

FIG. 7 is a further arrangement of an interrelated pressure regulator assembly.

### DETAILED DESCRIPTION OF THE PREFERRED EMBODIMENTS

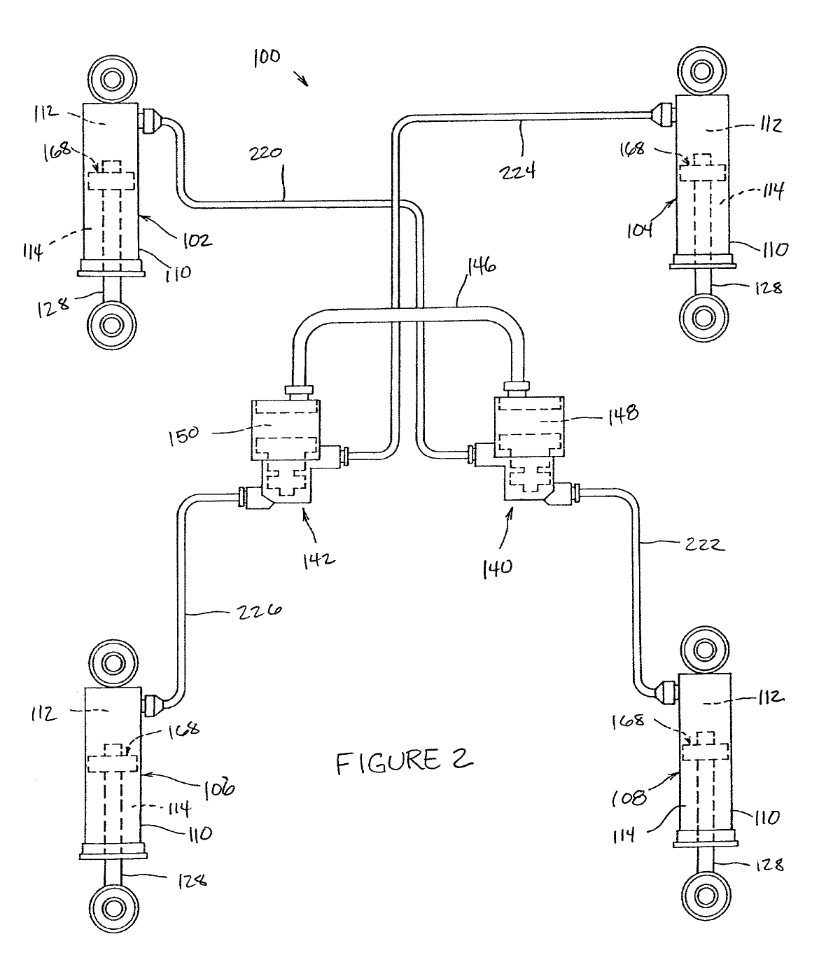

With reference now to FIG. 2, a suspension system which is generally indicated by the reference numeral 100 is illustrated therein. The suspension system 100 preferably is arranged and configured in accordance with certain features, aspects and advantages of the present invention. The suspension system 100 preferably is designed for use in vehicular applications, such as automobiles having multiple suspended supporting members, such as four wheels. In one preferred arrangement, the suspension system 100 is used in an automobile having a pair of front wheels (i.e., a front-left wheel and a front-right wheel) and a pair of rear wheels (i.e., a rear-left wheel and a rear-right wheel). Of course, those of ordinary skill in the art will readily appreciate other applications in which a suspension system arranged and configured in accordance with certain features, aspects and advantages of the present invention can also be used.

With reference still to FIG. 2, the suspension system 100 generally comprises a front left cylinder 102, a front right cylinder 104, a rear left cylinder 106 and a rear right cylinder 108. In the illustrated arrangement, each of the cylinders 102, 104, 106, 108 is configured identically to the other cylinders. However, it is anticipated that the cylinders 102, 104, 106, 108 can be configured to have different sizes, shapes and other configurations in other arrangements. For instance, to accommodate variations in loading, the rear cylinders can have an increased size.

Each cylinder generally comprises a cylinder body 110. Within the cylinder body 110 are defined an upper chamber 112 and a lower chamber 114. As used herein, upper chamber and lower chamber should not be construed to necessarily restrict the arrangement from an arrangement wherein the illustrated upper chamber is actually a lower chamber and vice versa. In other words, the terms upper and lower are with respect to the illustrations of the presently preferred arrangement. In some applications, the construction can be inverted and may, in some applications, extend in a more horizontal manner.

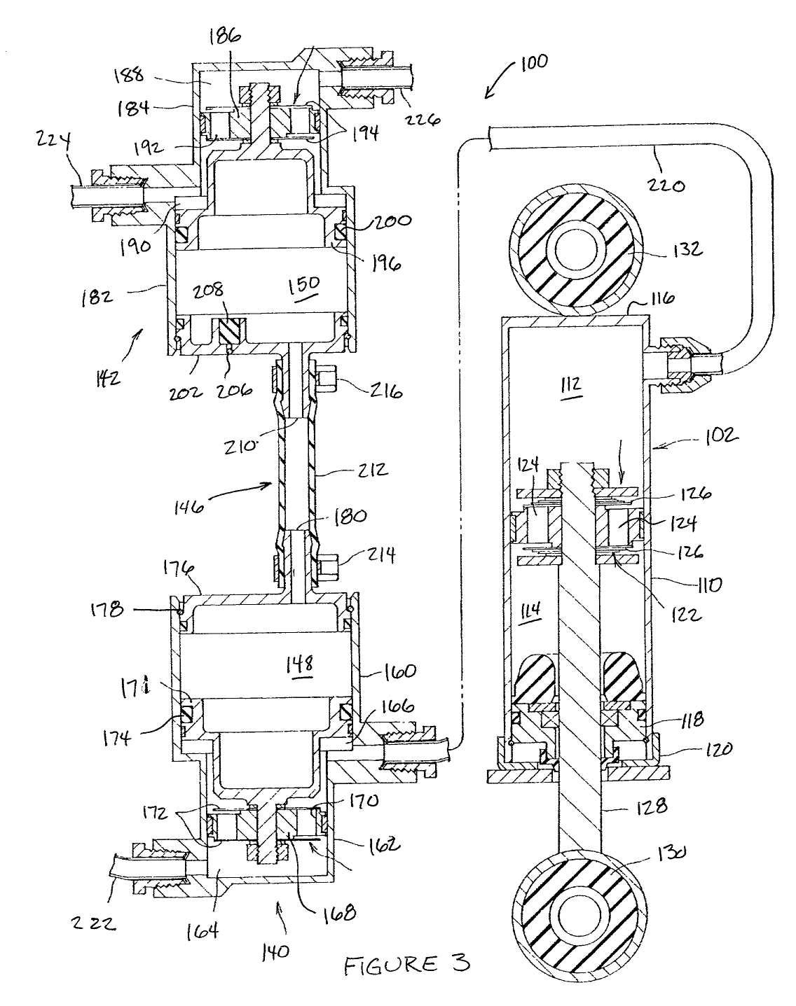

With reference now to FIG. 3, the cylinders will be described in more detail. More particularly, the cylinder 102 will be described, as the other cylinders 104, 106, 108 in the presently preferred arrangement are similarly constructed. As described above, the cylinder 102 comprises a cylinder body 110. The cylinder body 110 is preferably an enclosed cylinder such that has an enclosed upper end 116. A lower end is enclosed by a cap 118 that is positioned within the cylinder body 110. An outer cap 120 also can be positioned over the lower end of the tube defined by the cylinder body 110.

A piston 122 is capable of reciprocating within the bore defined by the cylinder body 110. The piston 122 preferably contains a number of through passages 124 such that the upper chamber 112 and the lower chamber 114 are placed in selective fluid communication. More preferably, a set of valve discs 126 are provided on either side of the piston 122. The valve discs 126 control flow through the apertures 124. In the illustrated arrangement, the apertures 124 located on the left hand side of the figure place the lower chamber 114 in communication with the upper chamber 112 when the piston 122 moves downward in the figure. Similarly, in the illustrated arrangement of FIG. 3, the aperture 124 located on the right side of the illustrated arrangement is selectively closed by the valve disc 126 positioned on the bottom side of the piston 122 and the aperture 124 places the upper chamber 112 in selective communication with the lower chamber 114 during upward movement of the piston 122.

The piston 122 is connected to a piston rod 128 in any suitable manner. The piston rod, in turn, is connected to the vehicle body or wheel through a damped mounting arrangement 130. Similarly, the cylinder body 110 is connected to the other of the vehicle wheel or vehicle body through a damped mounting arrangement 132. In a preferred arrangement, the cylinder body 110 is connected with the mounting arrangement 132 to the vehicle body while the piston rod 128 is connected to the wheel or other sprung member through the damped mounting arrangement 130. The damped mounting arrangements 130, 132 absorb vibration and other small movements to reduce the transfer of vibrations from the frame to the wheel or the wheel to the frame.

With reference again to FIG. 2, the front-left cylinder 102 and the rear-right cylinder 108 are connected together through a first pressure regulator 140. Similarly, the left-rear cylinder 106 and the front-right cylinder 104 are interrelated through a second pressure regulator 142. The first pressure regulator 140 and the second pressure regulator 142 are connected to each other through a high pressure chamber coupling 146. The high pressure coupling 146 places a high pressure chamber 148 of the first pressure regulator in fluid communication with a high pressure chamber 150 of the second pressure regulator 142 for reasons that will become apparent. Of course, in the arrangement illustrated in FIG. 2, the high pressure coupling 146 is formed as a conduit; however, other arrangements also can be used and some other arrangements will be described below.

With reference again to FIG. 3, the pressure regulators as well as the connection between the two illustrated pressure regulators will be further described therein. The pressure regulator 140 generally comprises a pair of cylindrical bodies. A larger of the cylindrical bodies 160 is connected to smaller of the cylindrical bodies 162. Of course, other arrangements also can be used. For instance, the bodies 160, 162 need not be cylindrical and the bodies need not be integrally formed, but the bodies 160, 162 can be separate members that are fluidly connected.

In the illustrated arrangement, a pair of chambers, a first chamber 164 and a second chamber 166 are defined within the pressure regulator 140 and are separated from one another by a piston 168. The piston 168 generally comprises a number of apertures 170 that preferably place the first chamber 164 in fluid communication with the second chamber 166. More preferably, flow controlling valves are used to selectively place the two chambers 164, 166 in fluid communication. In a presently preferred arrangement, a set of valve discs 172 are mounted to either side of the piston 168 in any suitable arrangement. The valve discs 172 control the flow through the apertures 170 in a manner similar to that described with respect to the piston 122 of the damper cylinder 102.

The piston 168 is connected to a carrying body 171. The carrying body 171 generally is positioned in sliding contact with the larger diameter portion 160 of the body of the first pressure regulator 140. The carrying body 170 is sealingly engaged with the inner surface of the pressure regulator 140 such that the high pressure gas chamber 148 is separated from the first chamber 164 and the second chamber 166. In the illustrated arrangement, a seal 174 is positioned around a peripheral portion of the carrying body 171. The seal 174 reduces or eliminates the flow of fluid into the high pressure gas chamber and vice versa.

With continued reference to FIG. 3, preferably the pressure regulator 140 also comprises an end cap 176. The end cap 176 further encloses the high pressure gas chamber 148 such that the high pressure gas chamber 148 is defined by the enlarged diameter portion 160 of the pressure regulator 140 in combination with the carrying body 170 and the end cap 176 in the illustrated arrangement. Preferably, the end cap 176 is secured in position using a snap ring 178. Of course, other mounting arrangements also can be used. For instance, the components can be threaded together, bolted together, welded together or otherwise permanently or semi-permanently attached to each other. The end cap 176 also comprises a connection port 180 for a purpose that will become apparent below.

With continued reference to FIG. 3, the second pressure regulator 142 preferably is similarly constructed to the first pressure regulator 140. By constructing the two components in similar manners, manufacturing costs can be reduced as the number of parts required is reduced. In general, the second pressure regulator 142 comprises an outer body having at least a large diameter portion 182 and a smaller diameter portion 184. Within the smaller diameter portion 184, a piston 186 is mounted. The piston 186 divides the smaller diameter portion into a first chamber 188 and a second chamber 190. The first chamber 188 and the second chamber 190 preferably are placed in selective fluid communication through apertures 192 that can be opened and closed using sealing valve disc arrangement 194 similar to those described above. Of course, other arrangements of limiting flow or controlling flow through the piston 186 can also be used.

The piston 186 preferably is mounted on a carrying body 196. The carrying body 196 preferably is positioned generally within the larger diameter portion 182 and separates a high pressure gas chamber 150 from the first chamber 188 and the second chamber 190. Preferably, a seal 200 is provided to seal the high pressure gas chamber 150 from the fluid containing chambers 188, 190.

It should be mentioned at this point, that the area or volume of the first chamber 188 and the second chamber 190 advantageously are sized such that movement of the carrying body 196 and the attached piston 186 causes equal volume changes or substantially equal volume changes within the chambers 188, 190. In this manner, if the dampers 102, 104, 106, 108 are all similarly sized and configured, substantially equal movements of the piston rods relative to the cylinders of the dampers will result in substantially equal displacements into or out of the chambers within the pressure regulators. Of course, if the dampers are unequally sized, the relative volumes within the chambers 188, 190 can be adjusted accordingly. In addition, in some applications, even if the sizes of the dampers is varied, the output of fluid can be arranged to be the same such that consistent sizing of the chambers 188, 190 can be maintained.

With continued reference to FIG. 3, the illustrated second pressure regulator 142 also comprises an end cap 202. The end cap 202 advantageously is provided with a port 206 that can be used to provide a charge of high pressure gas into the high pressure chamber 150. Because the high pressure chambers 148, 150 of the illustrated arrangement are fluidly connected, both chambers 148, 150 can be charged through the single portion 206. In the illustrated arrangement, the port 206 is plugged by a plug 208 after the high pressure chambers have received the charge. Additionally, the illustrated end cap 202 also comprises a connection port 210. The connection port 210 is configured as a nipple that receives a connecting tube 212 in the illustrated arrangement. Of course, other fluid connection members also can be used. For instance, any of a number of types of quick-connect hose couplings, permanent hose couplings and the like can be used.

The connecting tube 212 forms the high pressure coupling 146 in the illustrated arrangement. Preferably, the tube 212 is rubber and is sized and configured to be engaged on the ports 180, 210. In the illustrated arrangement, to secure the connecting tube 212 into position on the ports 180, 210, a pair of hose clamps 214, 216 are used. The hose clamps 214, 216 are used to tighten down on the connecting tube 212 once the connecting tube 212 has been disposed over the ports 180, 210. Of course, other manners of mounting the connecting tube 212 to the ports 180, 210 also can be used, as referred to above.

With continued reference to FIG. 3, a supply tube 220 is provided to connect the cylinder 102 to the pressure regulator 140. A second supply tube 222 is used to connect the pressure regulator 140 to the other cylinder 108. As also shown in FIG. 2, the second pressure regulator 142 is connected to the front right cylinder 104 with a third supply tube 224 into the left rear cylinder 106 with a fourth supply tube 226.

Thus, the illustrated suspension system 100 comprises a pair of parallel systems that are interconnected. More particularly, the illustrated system 100 advantageously comprises a pair of pressure regulators that are connected at the high pressure chambers. By connecting the high pressure chambers, increases and decreases in pressure within the individual chambers can be communicated between both pressure regulators. Thus, the change in the spring rate in each of the interconnected system can be equalized. In this manner, the damping of the individual systems results primarily from flow through throttled passages and the change in the spring rate does not cause dissention between the two systems.

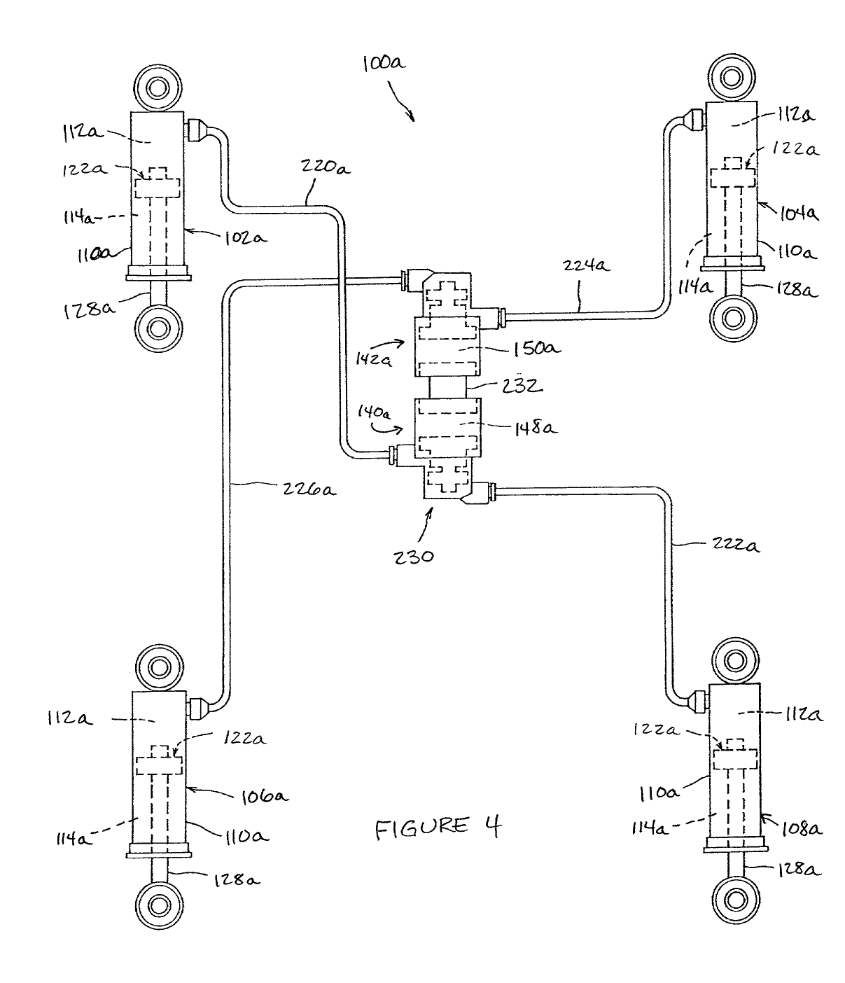

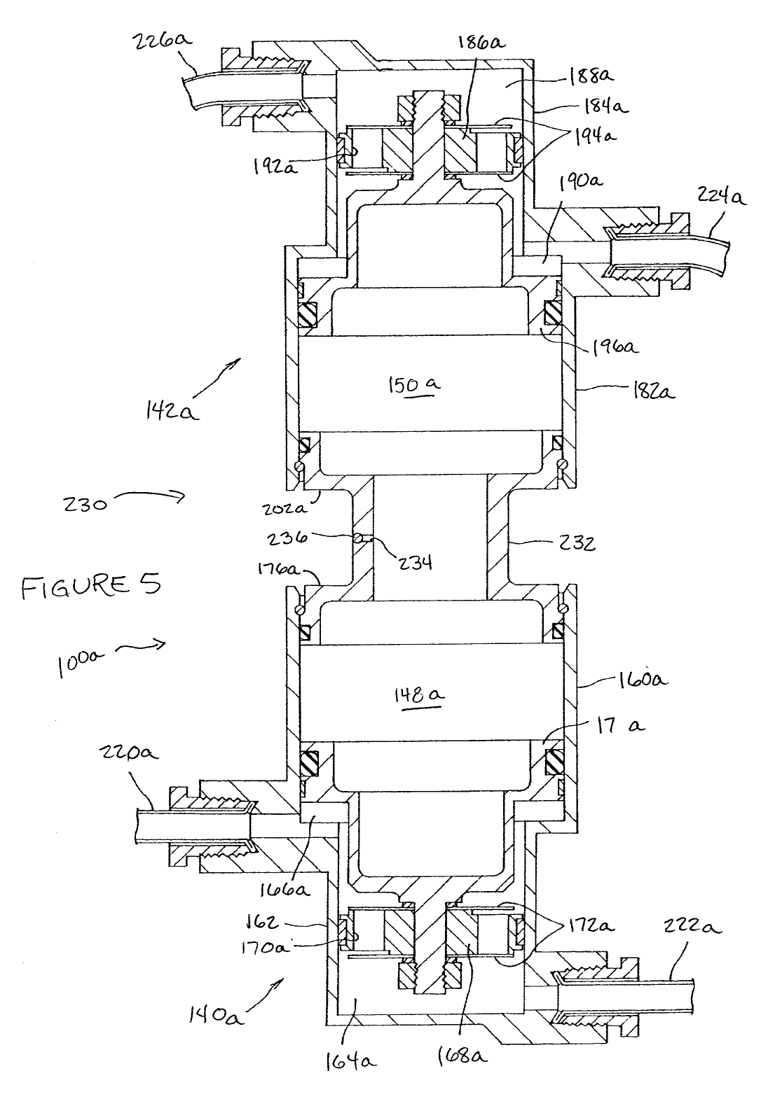

With reference now to FIGS. 4 and 5, another suspension system 100a is illustrated therein. The suspension system 100a has a number of components that are similar or identical in construction to the arrangement of FIGS. 2 and 3. Accordingly, where like components are being referred to, like reference numerals will be used with the addition of the suffix of a small letter “a.” Where components deviate, such deviation will be described unless otherwise understood by those of ordinary skill in the art.

In the illustrated arrangement of FIGS. 4 and 5, four cylinders 102a, 104a, 106a, 108a are interrelated through a pressure regulating assembly 230. The pressure regulating assembly 230 comprises a first pressure regulating portion 140a and a second pressure regulating portion 142a. A set of supply conduits 220a, 222a, 224a, 226a interrelate the cylinders 102a, 104a, 106a, 108a with the pressure regulating assembly 230.

As described above, each of the cylinders generally comprises a cylinder body 110a which is divided into an upper chamber 112a and a lower chamber 114a. The upper chamber 112a and the lower chamber 114a are separated by a piston 122a. The piston 122a is reciprocal within the cylinder body 110a and is carried on a piston rod 128a.

With continued reference to FIG. 5, the pressure regulating assembly 230, as discussed above, generally comprises the first pressure regulating portion 140a and the second pressure regulating portion 142a. The first pressure regulating portion 140a generally comprises a housing that defines a first chamber 164a and a second chamber 166a. The first chamber 164a preferably is separated from the second chamber 166a by a moveable wall such as a piston 168a. The piston 168a preferably includes a number of passages 170a that may or may not include throttles. The passages 170a can be selectively opened and closed through the use of valves. In the illustrated arrangement, the valves are valve discs, such as those indicated at 172a.

Preferably, the piston or moveable wall 168a is positioned within a smaller diameter portion 162a and is connected to a carrying body 171a. The carrying body 171a is in sliding contact with a large diameter portion 160a of the first pressure regulating portion 140a and extends into the smaller diameter portion 162a in the illustrated arrangement. As discussed above, other constructions of the pressure regulating portion 140a, including the configuration of the chambers 164a, 166a also are possible.

The second pressure regulating portion 142a is similarly constructed to the first pressure regulating portion 140a. In general, the second pressure regulating portion 142a comprises a first chamber 188a and a second chamber 190a. The first chamber 188a is generally separated from the second chamber 190a by a moveable wall or piston 186a. The moveable piston 186a generally comprises a number of apertures 192a which may or may not be throttled. The apertures 192a provide a fluid passage between the first chamber 188a and the second chamber 190a. This passage, however, can be selectively closed by a suitable valving arrangement, such as the valve discs 194a. The valve discs 194a preclude flow through at least one of the apertures 192a depending upon the direction of movement of the piston or moveable wall 186a.

The piston 186a preferably is housed within a smaller diameter portion 184a and preferably is connected to a carrying body 196a. The carrying body 196a preferably extends into and is in sliding engagement with a larger diameter portion 182a.

A pair of high pressure gas chambers 148a and 150a preferably are defined within the first pressure regulating portion 140a and the second pressure regulating portion 142a, respectively. In the illustrated arrangement, these chambers are partially defined by an open end cap assembly 232. The end cap assembly 232 actually provides a pair of end cap portions 176a, 202a. The end cap portions 176a, 202a in the illustrated arrangement can be integrally formed with each other to form the open end cap assembly 232. In other arrangements, however, the two end caps 176a, 202a can be separately formed and joined together by a coupling sleeve or other members.

In the illustrated arrangement, the end cap assembly 232 also comprises a port 234. The port 234 provides a place to inject high pressure gas into the chambers 148a, 150a. Once the gas has been injected, the port 234 may be plugged as through a plug 236. Such a construction results in free communication between both of the high pressure gas chambers 148a, 150a such that the pressure changes in the chambers can be generally equalized. Thus, the spring rate created by the effect of the high pressure gas chambers can be substantially equalized between the two interrelated sets of two cylinders.

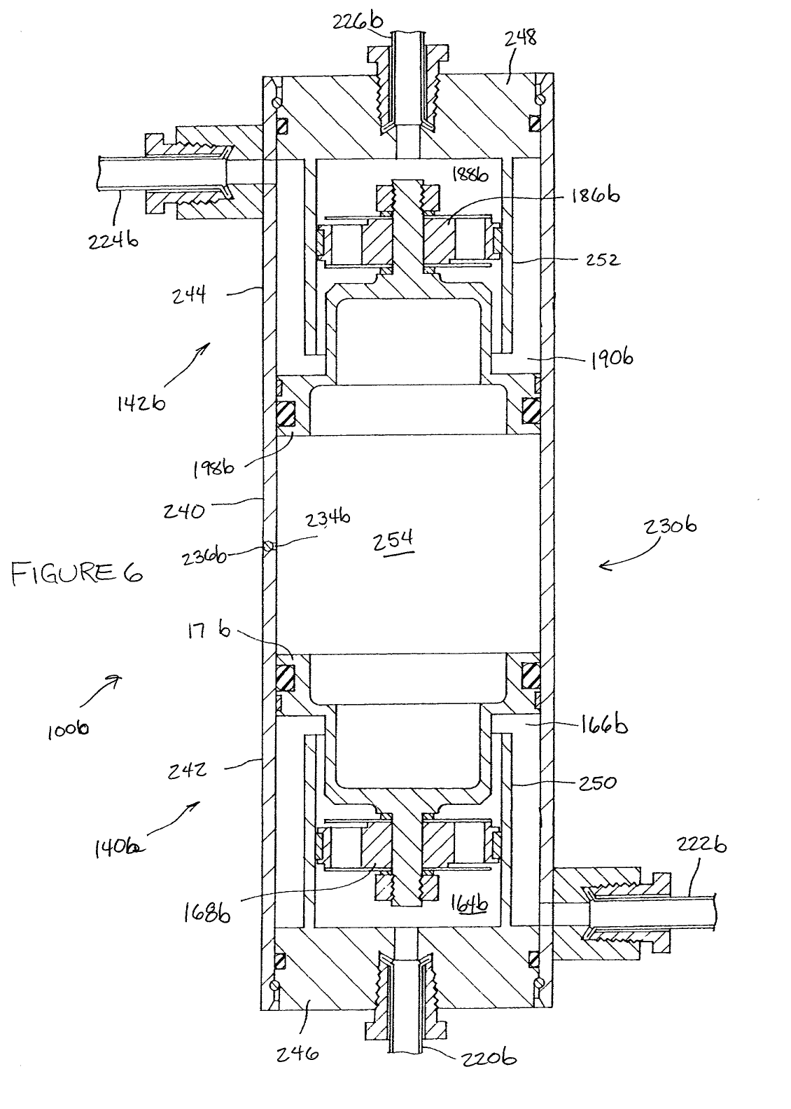

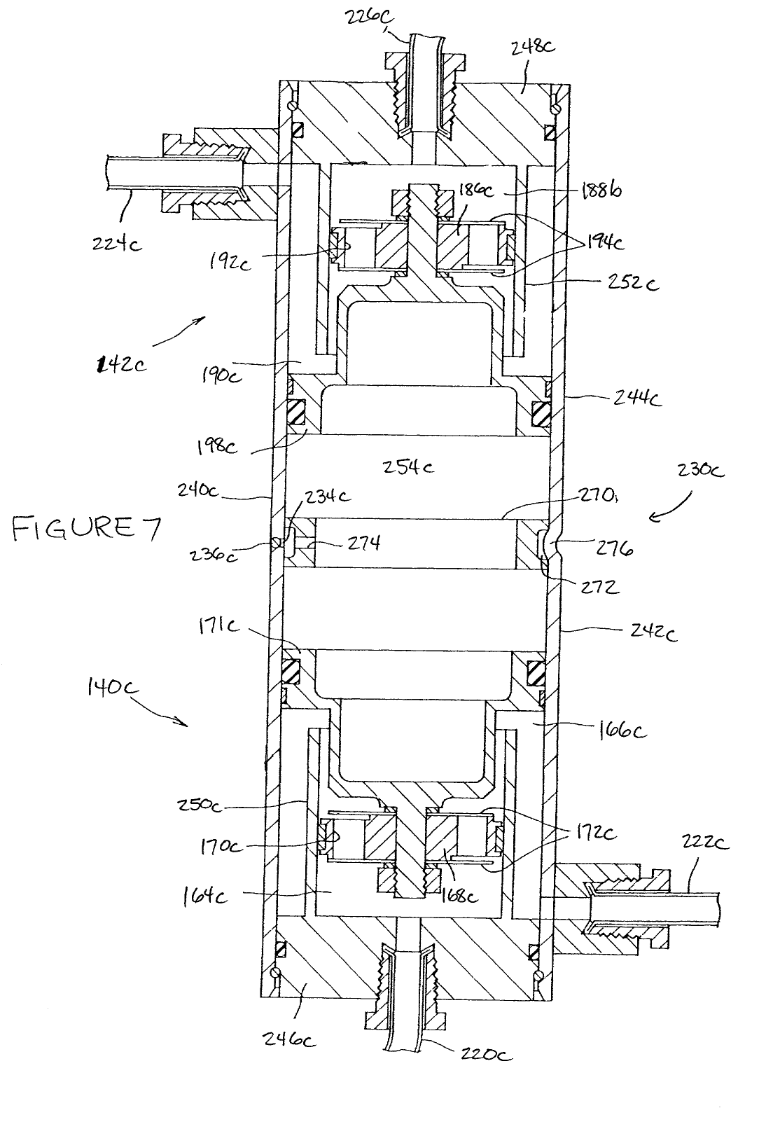

With reference now to FIGS. 6 and 7, two additional arrangements of suspension systems having certain features, aspects and advantages in accordance with the present invention will be described. Similar to the arrangements previously described, the arrangement of FIG. 6 will be described wherein like reference numerals from the earlier embodiments will refer to like elements, however, a suffix of the letter “b” will be used in FIG. 6. Similarly, in FIG. 7, a suffix of the letter “c” will be used to indicate components generally described in a previous arrangement. Where elements of the arrangements in FIGS. 6 and 7 are not described, the preceding descriptions apply to those elements in FIGS. 6 and 7 unless otherwise noted or understood by those of ordinary skill in the art.

With reference now to FIG. 6, a further arrangement of the suspension system 100b will be described. The pressure regulating assembly 230b generally comprises a first pressure regulating portion 140b and a second pressure regulating portion 142b. The first pressure regulating portion 140b places supply conduits 220b and 222b in selective fluid communication. These conduits are connected to cylinders that extend between the vehicle body and a suspended member such as a wheel.

In the illustrated arrangement of FIG. 6, the connection ports that connect the supply conduits to the pressure regulating assembly 230b have been adjusted relative to the arrangements of FIGS. 2-5. More specifically, the pressure regulating assembly 230b is generally formed with an outer cylindrical sleeve 240. The sleeve 240 can be subdivided into a first portion 242 and a second portion 244 which generally correspond to the first pressure regulating portion 140b and the second pressure regulating portion 142b, respectively. The ends of the cylinder 240 are enclosed by cap members 246, 248. In the illustrated arrangement, the supply conduits 220b, 226b are connected to these end caps 246, 248. Of course, in some arrangements, the supply conduits can be altered such that any one of supply conduits from a pair of cylinders can be connected to each of the end caps 246, 248.

Each of the end caps preferably contains an elongated collar 250, 252 that extends through a portion of the sleeve 240. In addition, the collar 250, 252 is radially spaced from the sleeve 240 in a manner that provides an annular chamber between the sleeve 240 and the respective collar 250, 252. In particular, the first portion 242 and the second portion 244 and the sleeve 250, 252 respectively define an annular chamber in the illustrated arrangement.

With continued reference to FIG. 6, a piston 168b is arranged for reciprocation within the sleeve 250. Thus, a first chamber 164b is defined between the end cap and the piston 168b while a second chamber 166b is defined as between the sleeve 250 and the first portion 242 of the sleeve 240. In the illustrated arrangement, the second chamber is an annular chamber; however, other constructions also can be used. As with the arrangements above, the chambers 164b, 166b are in fluid communication through apertures that are selectively opened and closed and that are formed within the piston 168b. In addition, similar to the arrangement described above, the piston 168b is carried on a carrying body 171b. The carrying body 171b is arranged for sliding contact with the inner surface of the cylinder 240.

The other portion 142b of the pressure regulating assembly 230b is similarly constructed to that described directly above. In other words, a first chamber 188b and a second chamber 190b are defined in similar manners to that described above and are separated by a piston 186b. The piston 186b is carried on a carrying body 198b. The carrying body is sealingly and slidably connected to the inner surface of the cylinder 240.

A gas pocket 254 is defined within the cylinder 240 between the two carrying bodies 170b, 198b. An inlet port 234b is provided in this portion of the cylinder 240. The inlet port 234b can be used to charge the high pressure chamber 254 with a high pressured gas supply or other type of pressurizing agent. Once the chamber 254 has been pressurized, a plug 236b can be used to seal the chamber 254. It should be noted at this point, that while the pressure regulators as being described herein in the multiple arrangements are each symmetrically formed with respect to each other, in other arrangements and configurations, a portion of the pressure regulating assembly 230b could be configured with an arrangement from FIG. 6 while other half could be configured in accordance with any of the other arrangements described herein. Furthermore, symmetry is not necessarily required.

With reference now to FIG. 7, a further arrangement is illustrated therein and the reference numerals include the suffix letter “c”. In this arrangement, the pressure regulating assembly 230c comprises a cylindrical member 240c that has both ends sealed by end caps 246c, 248c, respectively. The supply conduits 220c, 222c, 224c, 226c are in fluid communication with each other in the manner described with respect to FIG. 6.

The cylinder 240c again is divided into a first portion 242c and a second portion 244c. Within the first portion 242c, a first chamber 164c is defined between a piston 168c and a portion of the end cap 246c. In particular, this chamber 164c is defined within a cylindrical wall defined by a sleeve 250c that is in the illustrated arrangement integrally formed with the end cap 246c. The piston 168c comprises a number of apertures 170c that are selectively opened and closed by disc valves or other suitable valving arrangements 172c. The first chamber 164c is in fluid communication therefore, through the passages 176c with a second chamber 166c.

The piston 168c is carried on a carrying body 171c. The carrying body 171c is arranged for sliding contact with the inner wall of the cylinder 240c. In particular, the carrying body 171c is arranged for sliding contact with the first portion 242c of the cylinder 240c.

The second portion of the pressure regulating assembly 230c also comprises the first chamber 188c that is separated from the second chamber 190c through the use of a piston or moveable wall 186c. The moveable wall 186c or piston comprises a number of apertures 192c that are selectively opened and closed by valve discs 194c or any other suitable valving arrangement. The piston is arranged for sliding contact with a sleeve 252c that extends through a portion of the second portion 244c of the pressure regulating assembly 230c. The sleeve 252c preferably is integrally formed with the end cap 248c.

The piston 186c is carried by a carrying body 198c. The carrying body 198c is arranged for sliding contact with the inner surface of the cylinder 240c.

A gas chamber 254c is defined generally within the cylinder 240c between the two carrying bodies 171c, 198c. Generally disposed in the center of the chamber 254c is a dividing wall or stop 270. The stop 270 is positioned about an inlet port 234c through which high pressure gas can be used to charge the chamber 254c. Of course, other locations for both the stop 270 and the inlet port 234c are possible and the two need not be aligned with each other.

As also described above, a plug 236c can be used to seal the port 234c after the high pressure chamber 254c has been charged. To accommodate this charging feature, the stop 270 preferably comprises an outer extending peripheral passage 272 and at least one or preferably more than one throughpassage 274. The peripheral passage 272 can extend completely around the stop 270 or can extend about just a portion of the stop 270. The throughpassage 274 preferably extends between the peripheral passage 272 and an inner passage extending axially through the stop 270. The inner passage, the throughpassage 274 and the peripheral passage 272 in combination allow fluid communication between the port 234c and the interior of the chamber 254c.

Preferably, the stop 270 is secured in position through an indention or other mechanical method to keep the stop 270 from translating within the cylinder 240c. In the illustrated arrangement, a single indention 276 is illustrated. However, it should be appreciated that a number of indentions positioned about the periphery of the cylinder 240c also can be used. Furthermore, members can be used to extend into an inner portion of the stop 270 to secure the stop in its axial location. For instance, bolts or members formed on the interior surface of the cylinder 240c can be used.

As will be recognized by those of ordinary skill in the art, the stop 270 can be used to limit the travel of the carrying bodies away from the end caps 246c, 248c. In the illustrated arrangement, the pistons are connected to a portion of carrying bodies and that portion of the carrying bodies will come into contact with the end caps to limit travel in either direction. Moreover, in the arrangement of FIG. 6, preferably the spacing between the carrying bodies is such that the carrying bodies will come into contact before the piston slides axially away from the end of the sleeve 250, 252. Such an arrangement advantageously reduces the likelihood that the assembly will become damaged due to the piston escaping its position between the chambers (i.e., . . . 164b, 166b or 188b, 190b).

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combination or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A suspension system comprising a first cylinder and a second cylinder, said first cylinder and said second cylinder being fluidly connected to a first pressure regulator, said system further comprising a third cylinder and a fourth cylinder, said third cylinder and said fourth cylinder being fluidly connected to a second pressure regulator, said first pressure regulator containing a first high pressure chamber and said second pressure regulator containing a second high pressure chamber, said first high pressure chamber and said second high pressure chamber being in fluid communication.

2. The system of claim 1, wherein said first high pressure chamber is at least partially defined by a first end cap that forms a portion of said first pressure regulator.

3. The system of claim 2, wherein said second high pressure chamber is at least partially defined by a second end cap that forma a portion of said second pressure regulator.

4. The system of claim 3, wherein said first end cap and said second end cap are integrally formed.

5. The system of claim 3, wherein a high pressure coupling joins said first end cap and said second end cap.

6. The system of claim 5, wherein said high pressure coupling comprises a rubber hose.

7. The system of claim 1, wherein said first high pressure chamber is at least partially defined by a first outer wall and said second high pressure chamber is at least partially defined by a second outer wall and said first and second outer walls are integrally formed.

8. The system of claim 7, wherein said first high pressure chamber and said second high pressure chamber are integrally formed.

9. The system of claim 7, wherein said first high pressure chamber and said second high pressure chamber are separated by a stopping member.

10. The system of claim 9, wherein said first high pressure chamber is also partially defined by a carrying body, said carrying body is axially moveable within said first pressure regulator and a range of movement of said carrying body is at least partially defined by said stopping member.

11. The system of claim 9, wherein said first pressure regulator comprises a first fluid chamber and a second fluid chamber, said first fluid chamber being defined within an axially extending sleeve and said second fluid chamber being at least partially defined between said axially extending sleeve and said first outer wall, said axially extending sleeve having an axial length, said first fluid chamber also being separated from said second fluid chamber by an axially moveable wall, said axially moveable wall being joined to said carrying body, said carrying body being spaced from said stopping member by a distance less than the axial length of said axially extending sleeve.

12. A suspension system comprising a first cylinder, a second cylinder, a third cylinder and a fourth cylinder, said first cylinder and said second cylinder being fluidly connected to a first portion of a pressure regulating assembly, said third cylinder and said fourth cylinder being fluidly connected to a second portion of a pressure regulating assembly, said first portion of said pressure regulating assembly comprising a first fluid chamber, said second portion of said pressure regulating assembly comprising a second fluid chamber, said pressure regulating assembly further comprising a high pressure chamber disposed between said first fluid chamber and said second fluid chamber, a first moveable wall being positioned between said first fluid chamber and said high pressure chamber and a second moveable wall being positioned between said second fluid chamber and said high pressure chamber.

13. The system of claim 12, wherein said high pressure chamber is defined between said first moveable wall and said second moveable wall between at least one outer wall.

14. The system of claim 13, wherein said high pressure chamber is subdivided into a first sub chamber and a second sub chamber.

15. The system of claim 14, wherein said first sub chamber and said second sub chamber are fluidly connected by a tube.

16. The system of claim 14, wherein said first sub chamber and said second sub chamber are fluidly connected by a passage formed in a stopper member disposed within said high pressure chamber between said first sub chamber and said second sub chamber.

17. The system of claim 16 further comprising a charging port formed adjacent said stopper member and being in fluid communication with said high pressure chamber.

18. The system of claim 17, wherein said stopper member comprises at least one peripheral passage that places said charging port in fluid communication with said high pressure chamber.

19. The system of claim 18, wherein said stopper member also comprises at least one transverse passage that extends between said peripheral passage and said high pressure chamber.
